(19) United States
(12) Patent Application Publication
(10) Pub. No.: US 2011/0207107 A1
(43) Pub. Date: Aug. 25, 2011

(54) ON-LINE CUSTOMIZABLE TEXTBOOK SYSTEM AND METHOD

(75) Inventors: Alison P. Cancilliari, Gibraltar, MI (US); Dino M. Cancilliari, Gibraltar, MI (US)

(73) Assignee: Complete Curriculum, LLC, Gibraltar, MI (US)

(21) Appl. No.: 12/708,985

(22) Filed: Feb. 19, 2010

(51) Int. Cl. G09B 5/00; G09B 7/00

(52) U.S. Cl. 434/309; 434/322

(57) ABSTRACT

The present disclosure relates to a method for providing on-line textbooks to students. The method may use a server having a memory. The server memory may be loaded with an electronic bookshelf accessible by a student and by a teacher through a log-in procedure while accessing a log-in portal. The electronic bookshelf may be populated with standard electronic textbooks that may be accessed and downloaded over a network by the student, with each standard electronic textbook including at least one lesson plan for a given subject. The electronic bookshelf may also be populated with at least one customized electronic textbook that may be accessed and downloaded by a student. The customized electronic textbook may be further modified to create a student version and a separate teacher version, with the teacher version including supplementary material of interest to the teacher for the lesson plan contained in the customized electronic textbook.

### FIELD

The present disclosure relates to learning materials that are provided on-line over a local area network (LAN) or over a wide area network (WAN), and more specifically to on-line text books that are able to be customized by teachers to tailor lesson plans to a student's ability.

### BACKGROUND

The statements in this section merely provide background information related to the present disclosure and may not constitute prior art.

With the widespread use and available of the Internet and wireless and wired networks, it is becoming increasing popular to access educational materials “on-line”. By “on-line” it is meant over a wide area network, such as the Internet, or possibly over a local area network. The ability to access educational materials on-line is especially desirable in areas where a student or teacher would need to travel relatively long distances to get to a classroom facility.

Presently available on-line educational materials, however, are somewhat limited in how the materials can be presented to students. Such presently available on-line educational materials also often do not permit “customizing” to enable a teacher to tailor textbook materials to meet the needs of individual students, and to make “customized” textbooks available on-line to selected students. Thus, with present day on-line educational systems, all the students in a given class often must use the exact same materials (e.g., the exact same textbook) for a given class. This may hold back advanced students that could benefit for modified lesson plans to challenge them. Conversely, the inability to modify lesson plans to accommodate students who may need to progress more slowly through given subject matter also can end up holding back certain students.

Presently available on-line education materials also are often limited in that a teacher is not able to create and set up “teacher” versions of customized electronic textbooks, which are available for viewing or downloading only to the teacher. Still further, presently available on-line textbooks are often limited in how they can be “previewed” on-line, with little or no preview material for a given textbook provided to students, parents or other individuals.

### SUMMARY

In one aspect the present disclosure relates to a method for providing on-line text books to students. The method may comprise providing a server having a memory. The server memory may be loaded with an electronic bookshelf accessible by a student and by a teacher through a log-in procedure while accessing a log-in portal. The electronic bookshelf may be populated with standard electronic textbooks that may be accessed and downloaded over a network by the student, with each standard electronic textbook including at least one lesson plan for a given subject. The electronic bookshelf may also be populated with at least one customized electronic textbook that may be accessed and downloaded by a student, the customized electronic textbook being related to subject matter of a specific one of the standard electronic textbooks. The customized electronic textbook may include at least one of a modified lesson plan and a customized lesson plan. The modified lesson plan may be created from a specific lesson plan of one of the standard electronic textbooks, with the specific lesson plan having been modified by the member to at least one of: include additional material to the specific lesson plan, or to delete material from the specific lesson plan. The customized lesson plan may be created by the member without using any material from the specific lesson plan. The customized electronic textbook may be further modified to create a student version and a separate teacher version, with the teacher version including supplementary material of interest to the teacher for the lesson plan contained in the customized electronic textbook. The server may also be used to enable at least one of the student and the teacher to download either one of the standard electronic textbooks, or the student version of the customized electronic textbook.

In another aspect the present disclosure relates to a method for forming an on-line electronic bookshelf that makes available a plurality of on-line learning materials to students and teachers. The method may comprise providing a server having a memory. The server memory may be loaded with an electronic bookshelf accessible by a student and by a teacher through a log-in procedure while accessing a log-in portal. The electronic bookshelf may be populated with standard electronic textbooks that may be accessed and downloaded over a network by the student, with each standard electronic textbook including a plurality of lesson plans for a given subject at a given grade level. The electronic bookshelf may also be populated with at least one customized electronic textbook that may be accessed and downloaded by a student. The customized electronic textbook may include at least one lesson plan for a given subject and represent a version of a corresponding standard textbook that has been modified by the teacher. The modification may be to at least one of include additional material to the corresponding standard textbook, or to delete material from the corresponding standard textbook. The electronic bookshelf may be organized so that the standard and customized electronic textbooks are categorized by both subject matter and grade level in the electronic bookshelf. The customized electronic textbook may be further modified to create a student version and a separate teacher version, with the teacher version including supplementary material of interest to the teacher for the lesson plan contained in the customized electronic textbook. The teacher version of the customized electronic textbook may be included in the electronic bookshelf with indicia indicating its availability only to teachers. The server may be used to enable the teacher or any of the students to download any one of the student versions of the standard electronic textbooks, but may prohibit any of the students from accessing or downloading the teacher versions of the standard electronic textbooks. The server may also be used to enable the teacher to download or access any of the teacher versions or the student versions of the standard electronic textbooks. The server may also be used to enable the teacher to download or access either the teacher version or the student version of the customized electronic textbook. The server may also be used to qualify downloading of the customized electronic textbook to only one or more individuals that have been previously specified by the teacher as being authorized to download the customized electronic textbook.

In another aspect the present disclosure relates to a system for providing on-line text books to students. The system may comprise a server having a memory. A network port may be in communication with the server and able to communicate over one of a wide area network or a local area network with a remotely located computer terminal being used by a student. The server may have loaded in the memory an electronic bookshelf accessible by a student and by a teacher through a log-in procedure while accessing a log-in portal. The electronic bookshelf may have loaded thereon at least one customized electronic textbook that is accessed and downloaded by a student, the customized electronic textbook being related to subject matter of a specific one of the standard electronic textbooks, and including at least one of a modified lesson plan and a customized lesson plan. The modified lesson plan may be created from a specific lesson plan of the specific one of the standard electronic textbooks. The modified lesson plan may be constructed by having the member either include additional material into the specific lesson plan, or by deleting material from the specific lesson plan. The customized lesson plan may be created by the member without using any material from the specific lesson plan. The customized electronic textbook further may include a student version and a separate teacher version, with the teacher version including supplementary material of interest to the teacher for the lesson plan contained in the teacher version of the customized electronic textbook. The server may be configured to enable at least one of the student and the teacher to download either one of the standard electronic textbooks or the student version of the customized electronic textbook.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level block diagram illustration of major components that may be used with the system and method of the present disclosure;

FIG. 2 is a flowchart of operations that may be performed by a teacher in creating a new customized textbook or editing an existing customized textbook;

FIG. 3 is a flowchart of operations that may be performed by the system of FIG. 1 in notifying a student that a customized electronic textbook is available for downloading;

FIG. 4 is an illustration of a screen that a member may see when using the system to construct a customized electronic textbook; and

FIG. 5 is an illustration of a screen that a member or student may see when using the system to view her/his “My Bookshelf” section, which displays her/his standard and customized electronic textbooks that have been downloaded.

### DETAILED DESCRIPTION

The following description is merely exemplary in nature and is not intended to limit the present disclosure, application, or uses. It should be understood that throughout the drawings, corresponding reference numerals indicate like or corresponding parts and features.

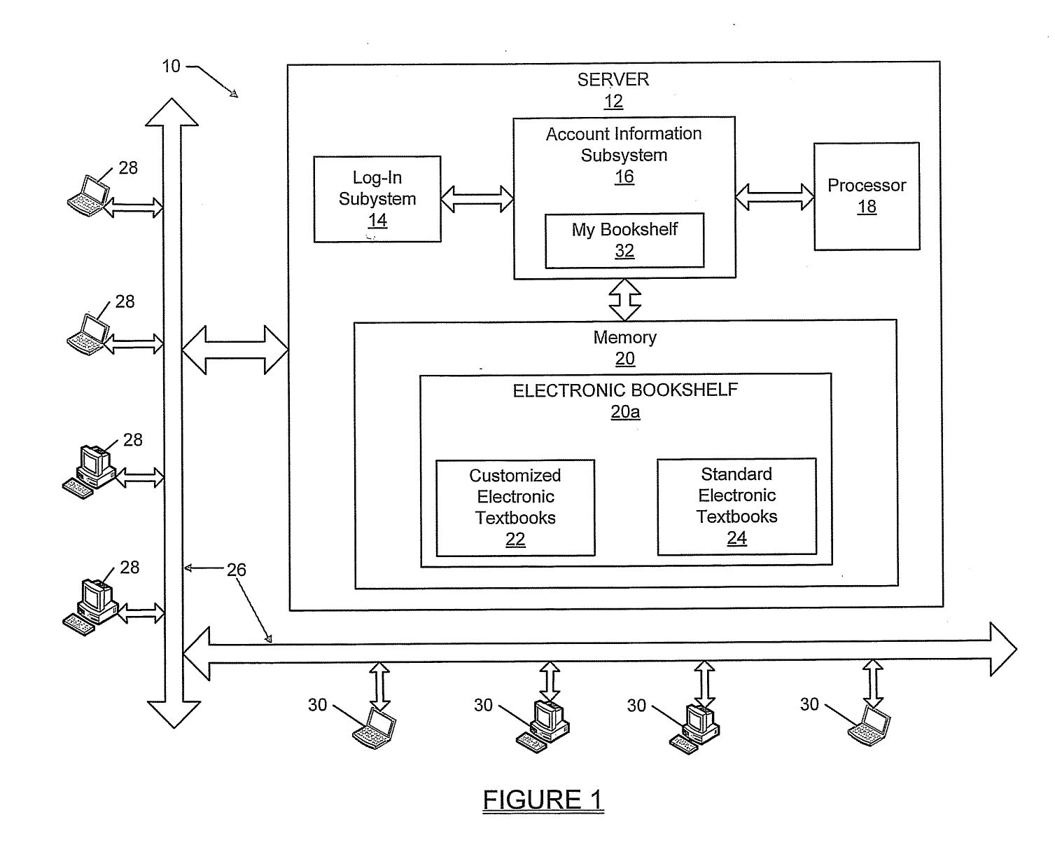

Referring to FIG. 1 there is shown one embodiment of a system 10 in accordance with the present disclosure. The system 10 may generally include a server 12 having a log-in subsystem 14, an account information subsystem 16, a processor 18 and a memory 20. The memory 20 may form a database for containing an electronic bookshelf 20a that includes customized digital electronic textbooks 22 (hereinafter “customized electronic textbooks 22”) and standard digital electronic textbooks 24 (hereinafter “standard electronic textbooks 24”). The log-in subsystem 14 interfaces with a network 26, for example either a wide area network such as the Internet, or a local area network (LAN). For the purpose of this discussion it will be assumed that the network 26 forms a wide area network, although in practice a combination of wide area and local area networks may be in communication with one another to provide communications with the server 12. It will also be understood that the terms “member” and “teacher” will be used interchangeably, with a “teacher” actually being just one classification of individuals that may form “members”. Although the term “teacher” may be used in explaining a specific aspect of the system 10, it will thus be appreciated that a “member” may include not just teachers but also administrators or other persons connected with an educational facility that have a need to access the system and potentially author (or compile) customized electronic textbooks or to access standard electronic textbooks. The system 10 may even be configured to recognize “members” as including a parent of a student.

The network 26 is in communication with one or more students who may access the server 12 via one or more corresponding computer terminals 28. It will be appreciated that terminals 28 may be in remote locations, such as at the homes of individual students, or they could be in one or more buildings on an educational campus (e.g., a college or technical school), or they could be located in a combination of such various locations. Thus, the terminals 28 may be located virtually at any location where network access exists. An additional plurality of computer terminals 30 that are accessed by teachers are also in communication with the server 12 via the network 26. The teacher computer terminals 30 could also be located in the homes of individual teachers, within a school (e.g., elementary, middle or high school), or in one or more buildings on a college or educational campus, or a combination of such settings.

A student or a teacher attempting to access the server 12 has his/her access request initially handled by the log-in subsystem 14. Log-in information is communicated between the log-in subsystem 14 and the processor 18, which looks at the log-in information and obtains an account profile of the individual attempting to log in from the account information subsystem 16. The account profile of the individual attempting to log in will determine the level of access and downloading privileges that the individual is granted. Access may be granted on one or more levels, depending upon a membership level that the user has signed up for. Presently four distinct levels of access are provided: 1) “Visitors”, where individuals that have not signed up for memberships yet are provided limited access through a website to preview electronic textbooks that are available for purchase; 2) “Registered Users” (or “Members”), who may be parents or teachers that have signed up for (or have been granted without a fee) a membership and have been granted a User Name and a User Password; 3) “Visitors-Students”, for those individuals who have been granted access by a Member to view and/or download a customized electronic textbook or a standard electronic textbook; and 4) “Back End Users”, for one or more individuals responsible for maintaining the contents of the electronic bookshelf 20a and the subscription information stored in the account information subsystem 16.

At the present time it is anticipated that educational institutions, such as Kindergarten through 12^{th} grade school districts, will be the predominant purchasers of subscriptions to use and implement the system 10. As such, it is expected that teachers and administrators will be provided with a level of access to the system 10 that allows full use of the system 10 and full downloading privileges. It is expected that students will be provided with a limited degree of access, granted by their teacher or by a school district administrator, that allows them to download only specific textbooks selected by the teacher or by an administrator. It is also expected that access to the system 10 will be provided to students at no charge to the students. Alternatively teachers, or possibly parents who are home schooling their child/children, may purchase subscriptions to access and use the system 10. With four year colleges, community colleges and trade schools, it is anticipated that the institution may make subscriptions to the system 10 available to students for a fee. Thus, students may be granted privileges to access and/or download specified materials from the electronic bookshelf depending upon fees and memberships that they (or their parents) have previously signed up and paid for, or that their school district has paid for. One or more levels of access may be granted to teachers as well, but it is anticipated that in many applications of the system 10, it will be most desirable to provide teachers with unlimited access to all electronic textbooks for those courses that a teacher is responsible for teaching. Individuals such as students or parents purchasing an electronic on-line textbook may be directed by the system 10 to a “checkout” page. At the checkout page appropriate credit card information can be input along with the information on specific electronic textbooks being purchased, similar to how purchase transactions are presently made on websites of on-line retail stores. The account information subsystem 16 may also include, for each student, a “Download Instant Textbook” section where the member has a list of all of the textbooks that she/he has purchased (or which has/have been purchased for her/him), with an option to download each listed textbook if the downloading has not yet taken place. The downloading option may be provided by a link to a downloadable PDF file or possibly to a different file format that permits convenient downloading and reading of the electronic textbooks.

Once a student or teacher has been granted access to the system 10, the student or teacher may preview or download electronic textbooks for which she/he is authorized to obtain, in view of her/his membership level. In one implementation of the system 10, a teacher may notify one or more students by an email message that specific, customized electronic textbooks have been uploaded to the electronic bookshelf 20a, and are now available for downloading by those specific students. Thus, students may be notified individually that specific customized electronic textbooks are available for their downloading, or select groups of students may be notified. Through conventional email techniques, it is also possible that a select group of students is notified of a specific customized electronic textbook that has become available for downloading, but where the “Recipient” field of the email message hides the identities of the other recipients to the message. So in effect, only the person who receives the email sees herself/himself as the recipient, even though additional recipients received the same message. The email message may contain a link that automatically directs the student to the specific, customized electronic textbook that she/he is authorized to preview and/or download, once the log-in process is complete and the student is logged on to the system 10.

Teachers are granted access to the system 10 to both upload electronic textbooks to the system as well as to download textbooks therefrom. It is anticipated that in most instances a given teacher will be granted permission to access either standard electronic textbooks or customized electronic textbooks for those courses that she/he is teaching. Thus, in the case of customized electronic textbooks, the teacher is able to modify them even after they are uploaded to the electronic bookshelf 20a. However, the system 10 may restrict a teacher from adding lesson plans or deleting lesson plans from a given customized electronic textbook once the customized electronic textbook has been “published” to students. This feature will be described in greater detail in the following paragraphs.

The specific electronic textbooks that may be contained in the electronic bookshelf 20a may be for any subject that is taught in a grade school, a middle school, a high school, a four year college, a community college, a trade/technical school, or a strictly on-line-only learning institution. It is anticipated that for Kindergarten through grade 12 applications, the electronic textbooks will be organized in the electronic bookshelf by both grade level and by subject matter.

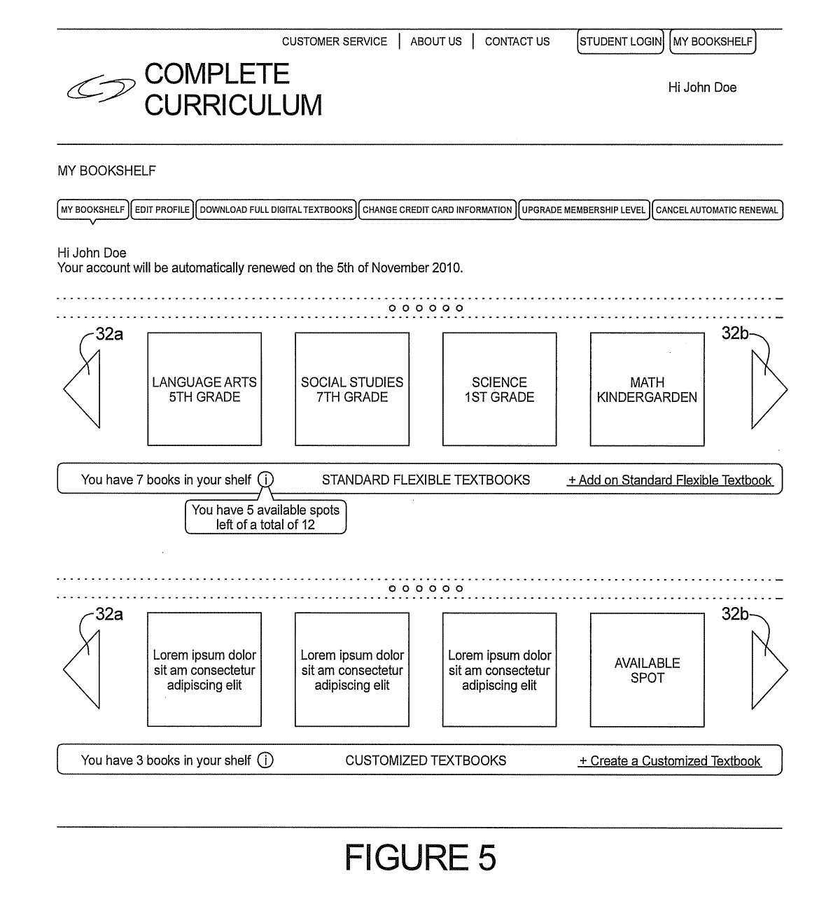

The account information subsystem 16 may include a “My Bookshelf” section 32 for each user that has signed up for a membership, or for each teacher that has been granted “member” status without having paid a fee. The My Bookshelf section 32 thus forms a private on-line bookshelf that each paid user or member is provided by the system 10 where a copy of each standard on-line textbook and each customized on-line textbook that that individual has purchased, or otherwise downloaded, is kept. Thus, in the event the student loses a previously purchased and downloaded textbook (whether standard or customized), the student is able to easily download another copy. One exemplary layout for the My Bookshelf section 32 is shown in FIG. 5. Buttons 32a and 32b may be provided to allow the member or student to scroll through the textbooks in her/his My Bookshelf section.

Standard On-Line Textbooks

Two versions of each standard electronic on-line textbook may be provided: a “student version” and a “teacher version”. The teacher version may include any annotations, notes or materials that are helpful to a teacher in using or evaluating materials contained in the standard textbook. The student version is available through downloading to either a student or a teacher, but the teacher version is only available for downloading by the teacher. However, it is anticipated that some institutions may wish to provide parents of K-12 grade level students with the option of purchasing a teacher version of the standard electronic on-line textbook that the student is using.

Each standard on-line textbook available for viewing may include: 1) Title page; 2) Copyright notice page; 3) Acknowledgements page; 4) Forwards page; 5) Introduction page; 6) Table of Contents page; 7) a Half Title page which further describes the text content 8) up to 180 lesson plans (or potentially more) via 360 PDF files (180 PDF files for the student version and 180 PDF files for the teacher version); and 9) up to 150 ancillary (or potentially more) PDF files, which may be the same for student and teacher versions of the textbook.

Each student version of the standard electronic textbook may be made available for preview to students or parents prior to purchasing the textbook. The preview may be made available through the account information subsystem 16 to provide a short sample of the course material contained in a given standard electronic textbook of interest. The short sample may include a video file that may be played on a suitable player of the user's computer, a downloadable file (e.g., PDF file) that includes a table of contents list, or one of the lesson plans contained in the textbook, or any combination of the above items that gives the student or parent an overview of the content of the standard electronic textbook before a purchase decision is made.

Customized Electronic Textbooks

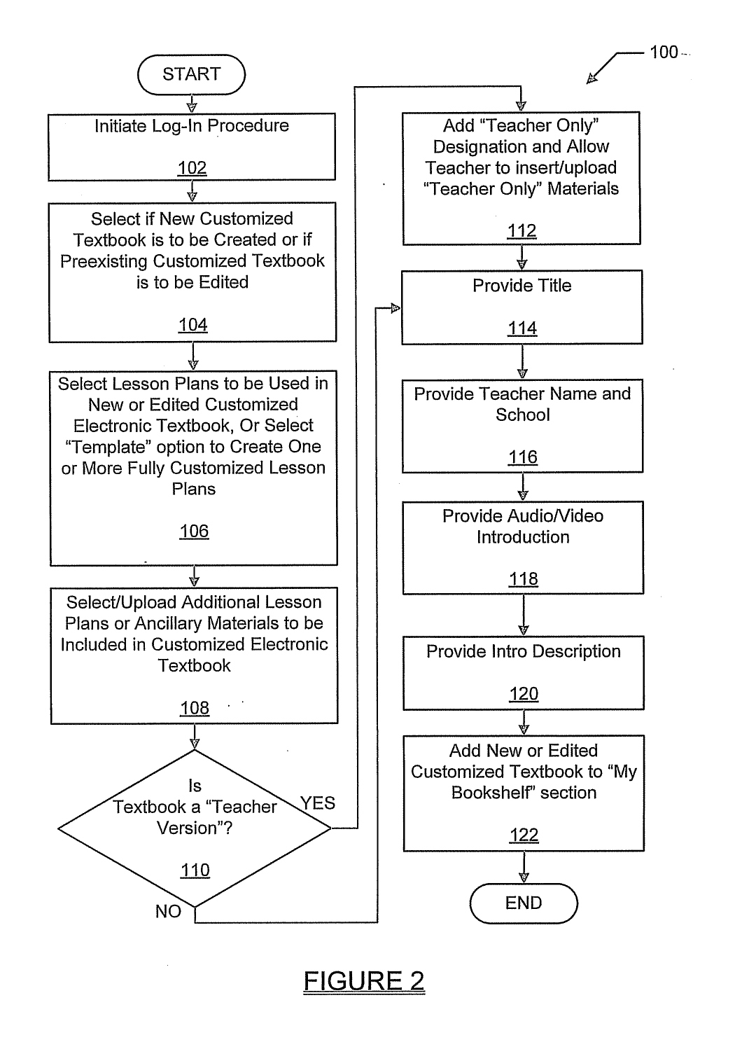

Members (i.e., teachers or parents) are able to create or edit a customized textbook from a corresponding standard electronic textbook. With reference to FIG. 2, a flowchart 100 is shown of various operations that may be used by a member in creating or editing a customized electronic textbook. For example, starting at operation 102, the member signs in with her/his user name and password information. Once the login is recognized by the login subsystem 14 and the processor 18, the member may be presented with a web page that allows the member to select whether a new customized text is to be created from a standard electronic textbook, or whether a pre-existing customized electronic textbook is to be edited, as indicated at operation 104, and to specify the specific textbook of interest that is to be used for this purpose. If a new customized electronic textbook is to be created, then the member specifies the standard electronic textbook (e.g., 7^{th} grade English) that is to be used to construct the new customized electronic textbook. Alternatively, if an existing customized electronic textbook is to be edited then the member specifies the particular customized electronic textbook by name to the system 10.

Regardless if a new customized electronic textbook is being created or a preexisting customized electronic textbook is being edited, the system 10 proceeds to operation 106 where the member may be presented with a checklist of the lessons and ancillaries contained in the corresponding standard electronic textbook that may be included in the new or edited customized textbook. If a preexisting customized electronic textbook was selected for editing, then a list of the lesson plans, ancillaries and supplemental material included in the preexisting customized electronic text is presented to the member. With a new customized electronic textbook, the member is able to select only those specific lesson plans from the corresponding standard electronic textbook that are to be included in the new customized textbook. The member is able to select lessons from any of the standard electronic textbooks that they have purchased or otherwise have access to, so the ability to mix and match lessons from multiple different textbooks is available.

An additional significant feature is the ability of the member to select an option for “Template”. Selecting the “Template” option allows the member to create their own, fully customized lesson plan to interject into the customized electronic textbook. Thus, the “Template” option allows the member to create one or more lesson plans that do not make use of any of the materials of pre-existing lesson plans of the corresponding standard electronic textbook for a given subject. Those members that are astute in creating lessons have the option of utilizing the “Template” option to create a fully self-authored text or instructional manual, with the same customizable options as members that utilize standard text material. Thus, the “Template” option could be used to allow a member to create all of the lesson plans contained in the customized electronic textbook, or merely to create a subset of the total lessons plans, with the remainder of the lesson plans being selected from one or more different standard electronic textbooks that the member has access to.

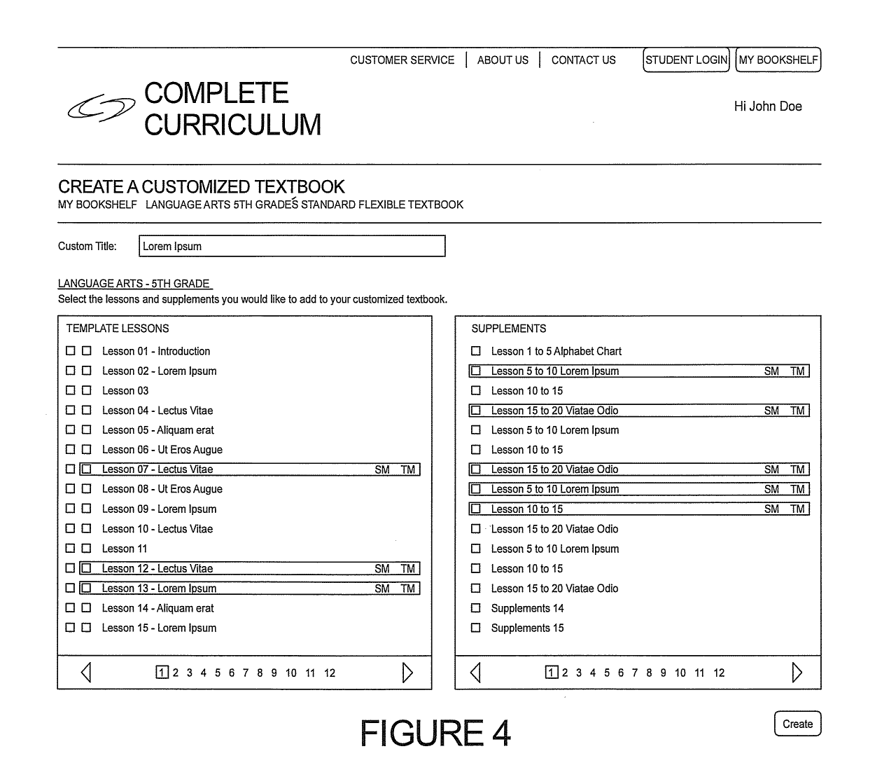

The “Template” option may be presented for each lesson plan when the member is constructing the customized electronic textbook. With brief reference to FIG. 4, one exemplary screen is shown to illustrate one possible screen layout that the member sees at her/his computer terminal when beginning to construct a customized electronic textbook. Each lesson plan may have a checkbox for “Template” that the member may select, which takes the member to a different screen where the member is able to upload other files in creating the fully customized lesson plan that would generally correspond to a specific one of the lesson plans of the standard electronic textbook. In addition, when creating a customized electronic textbook, an option for “Select All Materials” may be included so that the member can quickly choose all the existing materials from the standard electronic textbook, if desired, when creating a new customized electronic textbook.

At operation 108, whether creating a new customized electronic textbook or editing a preexisting customized electronic textbook, the member is able to upload other materials such as, without limitation, lesson plans from other electronic textbooks, audio/video files, PDF files, MSWORD® files, MSEXCEL® files; other text or graphics files, or to insert links to specific websites, to thus create what may be thought of as one or more “modified” lesson plans. Essentially any type of supplementary material that may be helpful to the student in understanding and learning the subject matter may be added to any of the lessons that are used to construct the customized electronic textbook by the member.

At operation 110 the member is provided with the option of designating the new customized electronic textbook as a “Teacher Version” or a “Student Version”. If a “Teacher Version” is selected, then at operation 112 the “Teacher Version” designation is applied to the textbook and the member is allowed to add further materials to each lesson of the electronic textbook that the member feels will be helpful to her/him in teaching the subject matter contained in the customized electronic textbook. Such additional materials might include one or more short videos of the teacher giving initial instruction on the particular lesson, or audio of the teacher guiding the student on the material and instructing what the student is required to do with the lesson. The teacher or parent (if the parent is designated as a member) may also add links to other web sites that enhance or reinforce the topic of instruction along with the ability to download additional teacher made documents, such as worksheets or project based instruction, to even further assist the student in mastery of the lesson.

Once operation 112 is completed, then at operation 114 the member is allowed to provide (or to change) the title for the customized electronic textbook. At operation 116 the member may provide her/his name and optionally her/his school that will be displayed in connection with the customized electronic textbook when it is included in the electronic bookshelf 20a. At operation 118 the member is allowed to provide (or change) an audio/video introduction for the customized electronic textbook. This introduction may also be made accessible to students and/or parents prior to purchasing the customized electronic textbook. At operation 120 an “Introductory description” for the textbook may be provided (or edited) by the member. The Introductory description may include a video, audio or text file. At operation 122 the new (or edited) customized electronic textbook may be added to the “My Bookshelf” section 32 of the system 10. Optionally the member may notify one or more students, via an email message, that the new or edited customized electronic textbook is available for them. A link may be included in the email message along with a unique user name and/or password. Clicking on the link takes the student directly to a download page where the customized electronic textbook may be downloaded after the appropriate user name and password information is entered.

Specific Contents of Customized Electronic Textbooks

In addition to the items described above in connection with FIG. 2, each customized electronic textbook may also include (without limitation) a 1) custom front cover; 2) a front matter, which is a descriptor of the text, background of the text and explanation of how the text can be utilized by the teacher; 3) a complete list of the lessons contained therein; 4) specific instructions/suggestions provided by the teacher/member for each lesson; 5) additional web links for each lesson plan; 6) additional files (PDF, .DOC, .XLS, .FLV, .MPG, .MOV) for each lesson plan; and 7) a title and accompanying list of ancillaries for the textbook. The ancillaries may include, without limitation, one or more of literary selections, progressive readers, alphabet charts and number lines. Each student or member may also be able to select a lesson or ancillary to view via a suitable viewer (e.g., Adobe ACROBAT® PDF file viewer), or to through print the lesson plan or ancillary.

Publishing Customized Electronic Textbooks

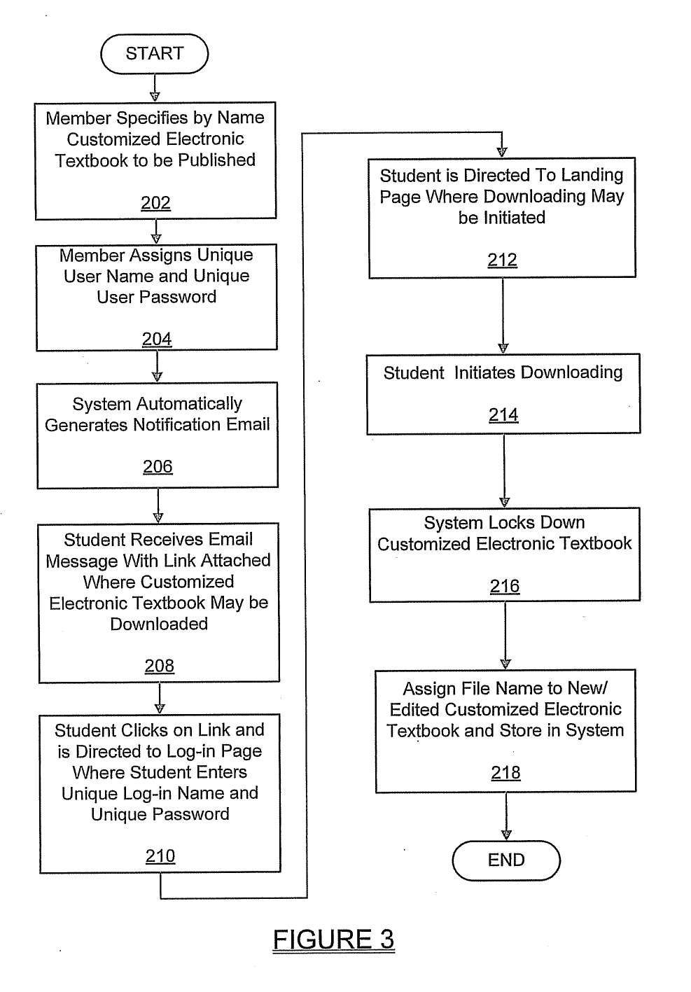

With reference to flowchart 200 in FIG. 3, the assigning and distribution of a customized electronic textbook will be described in greater detail. At operation 202, after a customized electronic textbook is created a member (or teacher) specifies it by name as a textbook that is to be published, the textbook will be able to be assigned to a student or a group of students. The member (or teacher) may assign a unique user name and unique user password for each specific customized electronic textbook that she/he creates, as indicated at operation 204. The system 10 then generates an email message at operation 206 which notifies a specific student or a group of students, of the availability of a customized electronic textbook. The system provides a specific URL, the teacher assigned unique user name and the teacher assigned unique password, when it generates the notification email to the one or more students. If the customized electronic textbook is a newly edited customized textbook (rather than a new customized textbook) the electronically generated email message that the system 10 generates may reflect that an updated version of a previously published customized electronic textbook is now available for downloading.

At 208 the student receives the email message with the link attached where the customized electronic textbook can be accessed. At operation 210 the student may click on the link, after which the student will be directed to a log-in page where the user may enter the unique user name and unique password that was provided in the previous notification email message. After correctly entering the unique user and unique password, the student may be automatically directed to a landing page where the customized textbook is available for downloading, as indicated at operation 212. Once the student is at the landing page she/he may select a “Download” option, as indicated at operation 214, to initiate the download.

After a new or edited customized electronic textbook has been published, the textbook may be “locked down”, as indicated at operation 216. By “published” it is meant made available for distribution to one or more students. By “locked down” it is meant that lesson plans may not be added to or deleted from the customized electronic textbook. However, it is preferred that members (e.g. teachers) still have the ability to update customized electronic textbooks by including additional links to video and audio files, instructions, descriptions, and documents such as PDF, .DOC, .XML and other files that help the student to learn the lesson plans. At operation 218 each newly created or newly edited customized textbook is assigned a file name and stored in the system 10. Storing may be in one or more locations, but it is preferred that a copy of each new and edited version of the customized textbook be stored in the “My Bookshelf” 32 section of the account information subsystem 16. Thus, each member has a listing of every single version of each customized electronic textbook that she/he has created. Other pertinent information such as “date of creation” of each version may be included so that the member can quickly see the titles and dates of each version of the electronic textbook that has been created.

Capability of PDF Files used with the System

The lesson plans and many of the related materials included in each standard electronic textbook and each customized electronic textbook (e.g., front covers, front matters, ancillaries, etc.) are preferably presented as PDF files using the browser running on the student's or member's computer. These files are displayed in a java script popup that is viewed using the browser's default PDF viewer. This allows various toolbars to be hidden so that only the document content is displayed to the student.

Within each lesson plan and each ancillary PDF file, users may perform a keyword search using the capabilities of the PDF reader they are using. Since the toolbars will be hidden, there may be a message presented to the user (i.e., student or member) with information on how to perform searching. The user also has the ability to scroll down or up within the entire PDF file for full access to its content.

The system 10 and method of the present disclosure thus forms a means by which standard and customized electronic textbooks can be created and made available to students, parents, teachers or education administrators via network. It is a significant advantage of the system 10 that standard textbooks can be easily modified by teachers to customize them for specific students. In addition, a wide variety of supplemental information in audio form, video form and textual form may be included in the customized textbooks by the teacher. Both the student version and the teacher version of each standard electronic textbook and each customized electronic textbook are saved in the system, and teachers have ready access to all versions of both types of textbooks. Helpful information is also provided for both standard electronic textbooks and customized electronic textbooks that enables students to preview the contents of each type of electronic textbook. The customized electronic textbooks are also made available to students through a unique distribution mechanism in which students are provided unique user names and passwords to access the textbooks that have been made available to them for downloading.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method for providing on-line text books to students, comprising:
providing a server having a memory;
loading on the server memory an electronic bookshelf accessible by a student and by a member through a log-in procedure while accessing a log-in portal;
populating the electronic bookshelf with standard electronic textbooks that may be accessed and downloaded over a network by the student, each said standard electronic textbook including at least one lesson plan for a given subject;
populating the electronic bookshelf with at least one customized electronic textbook that may be accessed and downloaded by a student, the customized electronic textbook being related to subject matter of a specific one of the standard electronic textbooks, and including at least one of:
a modified lesson plan created from a specific lesson plan of the specific one of the standard electronic textbooks, the modified lesson plan having been constructed by the member to at least one of include additional material into the specific lesson plan, and to delete material from the specific lesson plan; and
a customized lesson plan created by the member without using any material from the specific lesson plan;
further modifying the customized electronic textbook to create a student version and a separate teacher version; and
using the server to enable at least one of the student and the teacher to download either:
one of the standard electronic textbooks; or
the student version of the customized electronic textbook.

2. The method of claim 1, wherein:
at least one of the standard electronic textbooks is modified to include a student version and an independent teacher version, with the independent teacher version of the at least one standard electronic textbook being accessible only by the teacher; and
only the student version of the customized electronic textbook is modified.

3. The method of claim 1, wherein each said standard electronic textbook is classified on said electronic bookshelf by subject matter and by grade level.

4. The method of claim 1, wherein the electronic bookshelf is configured to list the standard electronic textbooks available for purchase and downloading, and wherein a detail page is provided for each said standard electronic textbook, the detail page being accessible by a student and configured to provide:
a title for a specific standard electronic textbook;
a description of content included in the specific standard electronic textbook;
a sample lesson included in the specific standard electronic textbook, the sample lesson further provided in a format suitable to be viewed with a corresponding file viewer; and
a price for the specific standard electronic textbook.

5. The method of claim 1, wherein the student version of the customized electronic textbook is formed by providing:
a custom title therefor;
a list of lessons contained within the customized electronic textbook;
subject matter for each of the lessons;
at least one of the lessons including an audio/video file that provides an introduction to the at least one lesson, and where the at least one lesson may include one or more of:
at least one additional link that directs a student to supplementary material for the at least one lesson; and
at least one additional document that may be accessed by the student through a conventional file viewer, where the at least one additional document is selected by the teacher to assist the student in understanding content of the at least one lesson.

6. The method of claim 5, further providing the customized electronic textbook with a list of ancillaries including at least one of:
literary selections;
progressive readers;
alphabet charts; and
number lines.

7. The method of claim 1, wherein the customized electronic textbook is available made available at a site that also includes at least one of:
a name of an individual that created the customized electronic textbook; and
a specific school that the customized electronic textbook is associated with.

8. The method of claim 1, wherein the teacher is able to assign the customized electronic textbook to at least one of:
a single student; and
a group of students.

9. The method of claim 1, further comprising:
saving the customized textbook on one of an independent memory or the memory of the server after the customized textbook is no longer available for downloading to a student.

10. A method for forming an on-line electronic bookshelf that makes available a plurality of on-line learning materials to students and teachers, the method comprising:
providing a server having a memory;
loading on the server memory an electronic bookshelf accessible by a student and by a teacher through a log-in procedure while accessing a log-in portal;
populating the electronic bookshelf with standard electronic textbooks that may be accessed and downloaded over a network by the student, each said standard electronic textbook including a plurality of lesson plans for a given subject at a given grade level;
populating the electronic bookshelf with at least one customized electronic textbook that may be accessed and downloaded by a student, the customized electronic textbook including at least one lesson plan for a given subject and representing a version of a corresponding standard textbook that has been modified by the teacher to at least one of:
include additional material to the corresponding standard textbook; or
to delete material from the corresponding standard textbook;
organizing the electronic bookshelf so that the standard and customized electronic textbooks are categorized by both subject matter and grade in the electronic bookshelf;
further modifying the customized electronic textbook to create a student version and a separate teacher version, the teacher version including supplementary material of interest to the teacher for the lesson plan contained in the customized electronic textbook, and including the teacher version of the customized electronic textbook in the electronic bookshelf with indicia indicating its availability only to teachers; and
using the server to enable the teacher or any of the students to download any one of the student versions of the standard electronic textbooks, but prohibiting any of the students from accessing or downloading the teacher versions of the standard electronic textbooks;
using the server to enable the teacher to download or access any of the teacher versions or the student or teacher versions of either of the standard electronic textbooks;
using the server to enable the teacher to download or access either the teacher version or the student version of the customized electronic textbook; and
using the server to qualify downloading of the customized electronic textbook to only one or more individuals that have been previously specified by the teacher as being authorized to download the customized electronic textbook.

11. The method of claim 10, further comprising configuring the electronic bookshelf to list all of the standard electronic textbooks available for purchase and downloading, and wherein a detail page is provided for each said standard electronic textbook, the detail page being accessible by a student and configured to provide:
a title for a specific standard electronic textbook;
a description of content included in the specific standard electronic textbook;
a sample lesson included in the specific standard electronic textbook, the sample lesson further provided in a format suitable to be viewed with a corresponding file viewer; and
a price for the specific standard electronic textbook.

12. The method of claim 10, further comprising providing the customized electronic textbook with a list of ancillaries.

13. The method of claim 10, further comprising making the customized electronic textbook available on the electronic bookshelf with:
a name of an individual that created the customized electronic textbook; and
a specific school that the customized electronic textbook is associated with.

14. The method of claim 10, wherein the student version of the customized electronic textbook is formed by providing:
a custom title therefor;
a list of lessons contained within the student version of the customized electronic textbook;
subject matter for each of the lessons;
at least one of the lessons including an audio/video file that provides an introduction to the at least one lesson, and where the at least one lesson may include one or more of:
at least one additional link that directs a student to supplementary material for the at least one lesson; and
at least one additional document in a portable document format (PDF) file that may be accessed by the student through a PDF file viewer, where the at least one additional document is selected by the teacher to assist the student in understanding content of the at least one lesson.

15. The method of claim 10, wherein both the student version of the customized electronic textbook and the teacher version of the customized electronic texted teacher version are prevented from having any additional lessons added thereto, or from deleting any said lessons contained therein, once made available on the electronic bookshelf.

16. The method of claim 15, wherein the teacher is able to add at least one of the following items to either the student version or the teacher version of the customized electronic textbook:
an additional link to supplementary material;
an additional video file including supplementary material;
an additional audio file including supplementary material; and
additional text instructions and commentary provided by the teacher concerning one or more of the lessons.

17. The method of claim 10, further comprising notifying specific students, via an email message, that the student version of a customized text book is available for downloading via a specific link.

18. A system for providing on-line text books to students, comprising:
a server having a memory;
a network port in communication with the server and able to communicate over one of a wide area network or a local area network with a remotely located computer terminal being used by a student;
the server having loaded in the memory an electronic bookshelf accessible by a student and by a teacher through a log-in procedure while accessing a log-in portal;
the electronic bookshelf having loaded thereon standard electronic textbooks that are accessed and downloaded over a network by the student, each said standard electronic textbook including at least one lesson plan for a given subject;
the electronic bookshelf having loaded thereon at least one customized electronic textbook that is accessed and downloaded by a student, the customized electronic textbook being related to subject matter of a specific one of the standard electronic textbooks, and including at least one of:
a modified lesson plan created from a specific lesson plan of the specific one of the standard electronic textbooks, the modified lesson plan having been modified by the member to at least one of include additional material to the lesson plan, and to delete material from the specific lesson plan; and
a customized lesson plan created by the member without using any material from the specific lesson plan, but which corresponds to the subject matter of the specific lesson plan;
the customized electronic textbook further including a student version and a separate teacher version, the teacher version including supplementary material of interest to the teacher for the lesson plan contained in the customized electronic textbook; and
the server configured to enable at least one of the student and the teacher to download either:
one of the standard electronic textbooks; or
the student version of the customized electronic textbook.

19. The system of claim 18, wherein each said standard electronic textbook is classified on said electronic bookshelf by subject matter and by grade level, and wherein said electronic bookshelf provide listing for said subject matter and grade to said students and said teacher.

20. The system of claim 18, wherein the student version of the customized electronic textbook is formed by providing:
a custom title therefor;
a list of lessons contained within the customized electronic textbook;
subject matter for each of the lessons;
at least one of the lessons including an audio/video file that provides an introduction to the at least one lesson, and where the at least one lesson may include one or more of:
at least one additional link that directs a student to supplementary material for the at least one lesson; and
at least one additional document that may be accessed by the student through a conventional file viewer, where the at least one additional document is selected by the teacher to assist the student in understanding content of the at least one lesson.
